(19) United States
(12) Patent Application Publication
(10) Pub. No.: US 2025/0305527 A1
(43) Pub. Date: Oct. 2, 2025

(54) SUPPORT DEVICE FOR BOARD PANELS, BOARD PANEL SUPPORT AND JUNCTION SYSTEM AND RELATED PREPARATION METHOD

(71) Applicant: BI-SILQUE, S.A., ESMORIZ (PT)

(72) Inventor: André VASCONCELOS, OVAR (PT)

(21) Appl. No.: 18/866,384

(22) PCT Filed: May 26, 2023
(86) PCT No.: PCT/PT2023/050013

§ 371 Date: Nov. 15, 2024

(30) Foreign Application Priority Data
May 30, 2022 (PT) 118021

(51) Int. Cl. F16B 7/02

(52) U.S. Cl. CPC F16B 7/02

(57) ABSTRACT

The invention refers to a support device for board panels having a connecting rod with a first end and a second end, a front bulkhead, an intermediate bulkhead, a rear bulkhead and an element connecting to a surface including an orifice, which are interconnected to each other. The invention also refers to a board panel support and junction system having the support device and the associated preparation method. The present invention has the advantage of connecting adjacent board panels such that the intervals formed between them are not apparent, wherein the board panels are, for example, board panels configured for writing or for fastening papers.

### TECHNICAL FIELD

The present invention refers to a support device for board panels, which is used in a board panel support and junction system used as office products, such as products to support teaching or as decorative products in constructions, for example households and apartments.

### BACKGROUND ART

In our daily lives, it is commonplace to use boards configured for writing, for example whiteboards and blackboards, or boards configured for supporting sheets of paper. Said boards can be used as products to support teaching and training in companies and schools, products for fixing notices or communications or even decorative boards, whereon photographs are fastened.

The boards of the state of the art have a limitation in situations where the need arises to position different boards in adjacent positions, since said boards usually have a frame, which prevents the suitable junction of the boards, because an interval between the adjacent boards is formed, resulting in a discontinuity of the set of boards, which entails drawbacks especially when the boards are those used for writing. Additionally, the interval also provides undesirable esthetic effects.

### Solution to Problem and Advantageous Effects of Invention

The present invention solves the problems of the state of the art by means of the development of a support device for board panels, which is configured to be encased into two adjacent board panels by means of rails, wherein the rails are connected to said board panels. The support device for board panels is part of a board panel support and junction system, wherein the interval formed between the adjacent board panels is filled and hidden by a T-profile element.

Accordingly, the present invention has the advantage of connecting adjacent board panels such that the intervals formed between them are not apparent.

### BRIEF DESCRIPTION OF DRAWINGS

With a view to promoting an understanding of the principles according to the embodiments of the present invention, reference will be drawn to the embodiments illustrated in figures and to the language employed to describe them. In any case, it should be understood that there is no intention of limiting the ambit of the present invention to the content of the drawings. Any subsequent alterations or modifications of the inventive characteristics illustrated herein, as well as any additional applications of the principles and embodiments of the invention illustrated, that would normally occur to one skilled in the art in possession of this specification, are considered to be within the ambit of the invention claimed.

FIG. 1 illustrates a front view of the support device for board panels;

FIG. 2 illustrates a top view of the support device for board panels;

FIG. 3 illustrates a bottom view of the support device for board panels;

FIG. 4 illustrates a rear view of the support device for board panels;

FIG. 5 illustrates a side view of the support device for board panels;

FIG. 6 illustrates a first perspective view of the support device for board panels;

FIG. 7 illustrates a second perspective view of the support device for board panels;

FIG. 8 illustrates a first insertion view of the support device for board panels in a board panel support and junction system;

FIG. 9 illustrates a second insertion view of the support device for board panels in a board panel support and junction system;

FIG. 10 illustrates a view of a profiled rails section;

FIG. 11 illustrates a perspective view of profiled rails;

FIG. 12 illustrates a perspective view of the support device for board panels;

FIG. 13 illustrates a perspective view of the support device for board panels;

FIG. 14 illustrates a perspective view of a T-profile element.

### DESCRIPTION OF EMBODIMENTS

In a first aspect, the present invention refers to a support device for board panels comprising:
a connecting rod (1) with a first end (2) and a second end (3); and
a front bulkhead (4), which has a first portion disposed in a preceding position relative to said connecting rod (1) and a second portion disposed on the connecting rod (1), wherein said first portion is connected to said second portion; and
a rear bulkhead (6), which is disposed in a posterior position relative to said connecting rod (1) and is connected to said second portion of the front bulkhead (4); and
an intermediate bulkhead (5), which is simultaneously connected perpendicularly to a lower face of the front bulkhead (4), connected perpendicularly to a lower face of the connecting rod (1) and connected perpendicularly to a lower face of the rear bulkhead (6); and
an element connecting to a surface including an orifice (7), which is connected to the rear bulkhead (6); wherein
a first gap (13) is bordered by a portion of the lower face of the front bulkhead (4), by a portion of the upper face of the connecting rod (1), by a portion of the lower face of the rear bulkhead (6) and by a portion of the right face of the intermediate bulkhead (5); and wherein
a second gap (14) is bordered by a portion of the lower face of the front bulkhead (4), by a portion of the upper face of the connecting rod (1), by a portion of the lower face of the rear bulkhead (6) and by a portion of the left face of the intermediate bulkhead (5).

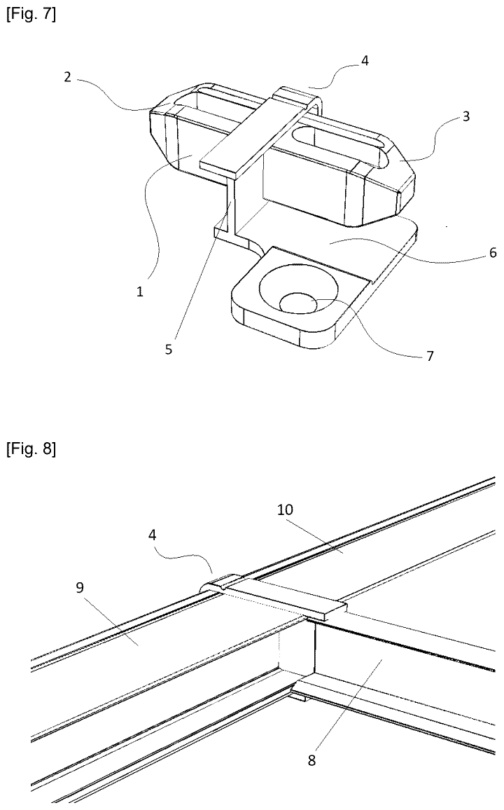

In the preferred embodiments of the present invention, the board (2) includes at least one entrance (6), at least one of the first end (2) and of the second end (3) are selected from the group consisting of a stem of a prism, a stem of a pyramid (as illustrated in FIGS. 2 and 5), a stem of a cylinder or a stem of a cone, as illustrated in FIG. 7.

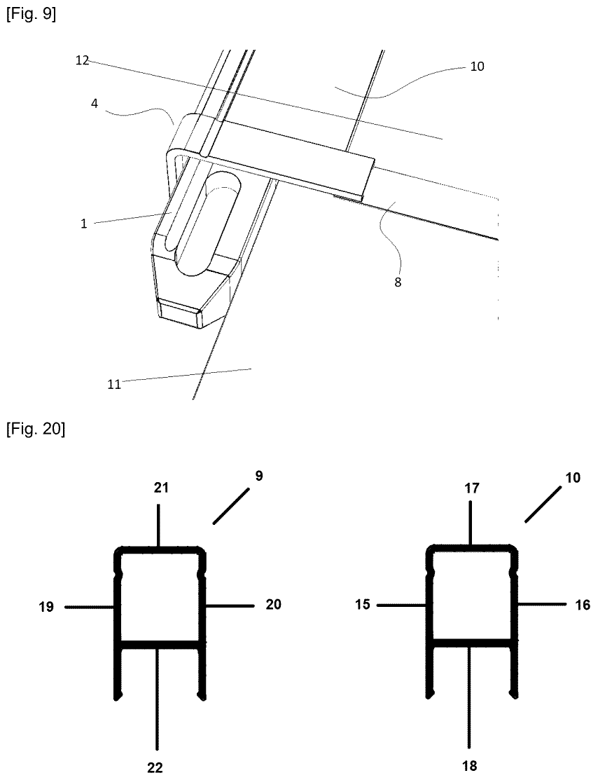

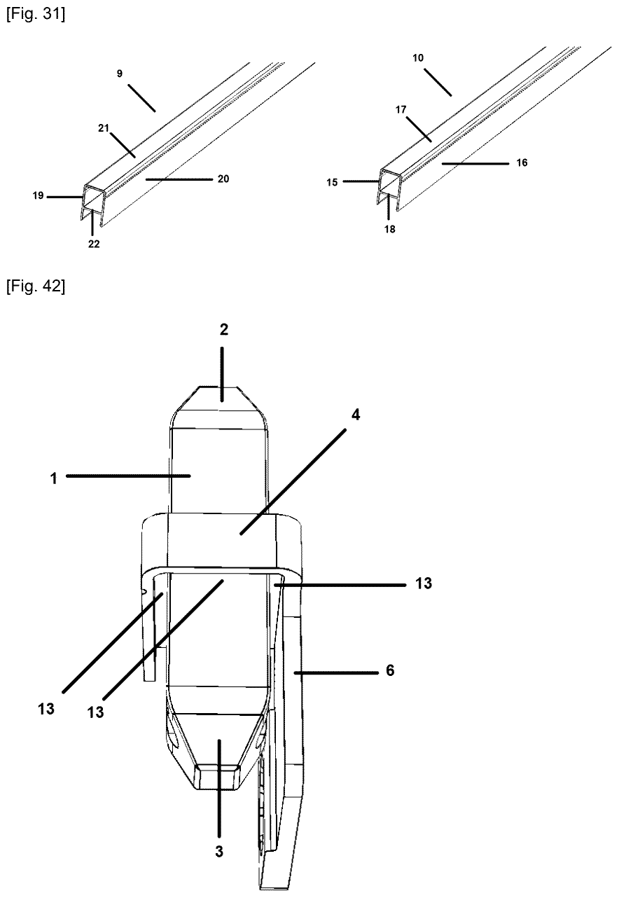

The first gap (13) and the second gap (14) of the support device for board panels are configured respectively for the insertion of a first profiled rail (10) and of a second profiled rail (9), as illustrated in FIGS. 8 and 9.

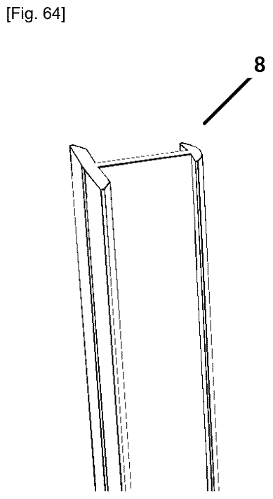

The borders and the extension of the first gap (13) and of the second gap (14) of the support device for board panels, relative to the front bulkhead (4), to the connecting rod (1), to the rear bulkhead (6) and to the intermediate bulkhead (5) are illustrated in FIGS. 12 and 13.

In the preferred embodiments of the support device for board panels, the connection between the intermediate bulkhead (5), the lower face of the front bulkhead (4), the lower face of the connecting rod (1) and the lower face of the rear bulkhead (6) configure an H-profile, as illustrated in FIG. 7. The H-profile is especially configured to act as bulkhead and encasement of a first profiled rail (10) and of a second profiled rail (9), as illustrated in FIG. 8.

In the preferred embodiments of the support device for board panels, the element connecting to a surface including an orifice (7) and the rear bulkhead (6) are on the same plane, as illustrated in FIGS. 3 and 7. Alternatively, as will be appreciated by those skilled in the art, the element connecting to a surface including an orifice (7) and the rear bulkhead (6) can be on different planes and parallel to each other, as illustrated in FIG. 6.

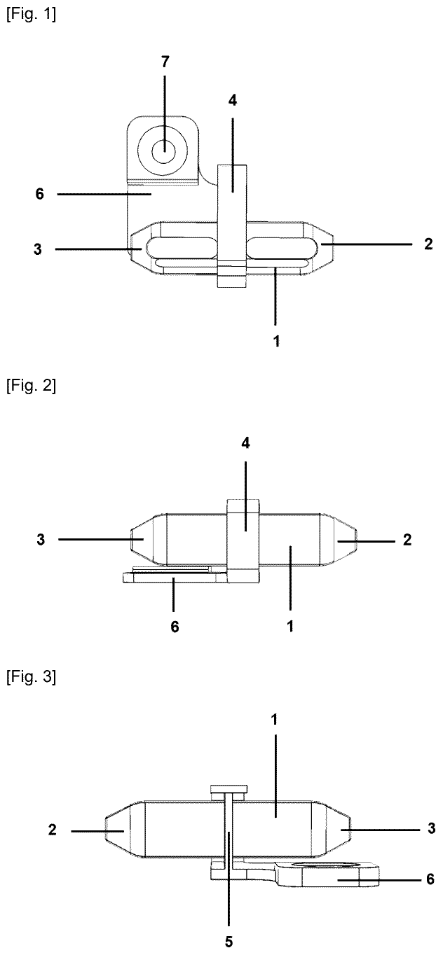

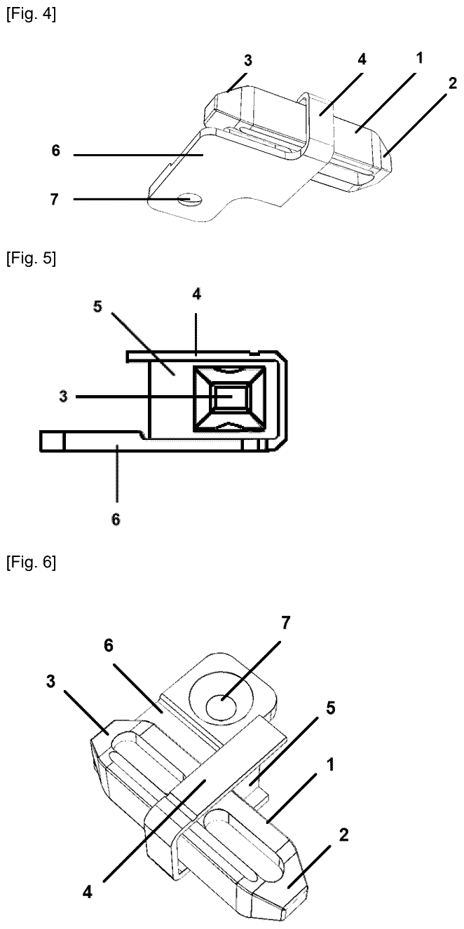

In the particularly preferred embodiments of the support device for board panels, the element connecting to a surface including an orifice (7) and the rear bulkhead (6) are disposed sideways relative to the plane including the intermediate bulkhead (5), as illustrated in FIGS. 1 and 4. Further preferably, the plane including the intermediate bulkhead (5) corresponds to a central position of the longitudinal length of the support device for board panels. These preferred embodiments have the additional advantage of allowing the support device for board panels to be fastened to a surface, even in a situation wherein a first profiled rail (10) or a second profiled rail (9) are connected to the support device for board panels and a first panel (12) or a second panel (11) are already respectively connected to the first profiled rail (10) or to the second profiled rail (9).

It will be understood by persons skilled in the art that the element connecting to a surface including an orifice (7) is configured for fastening the support device for board panels to a surface comprising a wall or any surface vertical on which board panels may be disposed. The present invention also comprises the installation thereof on horizontal surfaces, said as ceilings, or even slanted surfaces. Fastening means known by persons skilled in the art, for example nails or screws are used, to fix that of the support device for board panels to a surface, by means of the passage of the fastening means through the orifice (7).

In the preferred embodiments of the support device for board panels, each side of the connecting rod (1) comprises, relative to the intermediate bulkhead (5), at least one cavity, as illustrated in FIG. 7. The objective of inserting cavities into the connecting rod (1) is to reduce the quantity of material needed to prepare the support device for board panels.

In a second aspect, the present invention refers to a board panel support and junction system comprising a support device for board panels, as defined in the first aspect, and additionally comprises:
a first profiled rail (10), which has a first longitudinal plate (15) and a second longitudinal plate (16) orthogonally connected to a first cross plate (17) and to a second cross plate (18), wherein an encasement zone, bordered by said longitudinal plates (15, 16) and by said cross plates (17, 18), is configured to fit into the first gap (13) and to connect to the connecting rod (1) of said support device for board panels; and
a second profiled rail (9), which has a first longitudinal plate (19) and a second longitudinal plate (20) orthogonally connected to a first cross plate (21) and to a second cross plate (22), wherein an encasement zone, bordered by said longitudinal plates (19,20) and by said cross plates (21,22), is configured to fit into the second gap (14) and to connect to the connecting rod (1) of said support device for board panels; and
a first panel (12), which is configured to fit longitudinally into said first profiled rail (10); and
a second panel (11), which is configured to fit longitudinally into said second profiled rail (9); and
a T-profile element (8), which is configured to fit longitudinally into the interval formed between the first panel (12), the second panel (11) and the intermediate bulkhead (5) of said support device for board panels.

In the preferred embodiments of the board panel support and junction system of the present invention, at least one of the first panel (12) and of the second panel (11) are selected from the group consisting of a board configured for writing, a board configured for supporting sheets of paper, a board configured for supporting objects by magnetic means or a board configured for supporting sheets of paper by pins. A board with surface configured for writing may be, for example, a whiteboard of the type used in offices or classrooms. A board configured for supporting sheets of paper by pins can be made of cork or other material that can be perforated by paper fastening pins, as a person skilled in the art will understand. A board configured for supporting objects by magnetic means comprises a panel with magnetic properties to be magnetically connected to a pin or magnetic button, which supports sheets of paper between the pin or magnetic button and said panel.

As illustrated in FIG. 14, in the preferred embodiments of the board panel support and junction system of the present invention, the T-profile element (8) presents an upper longitudinal plate, a lower longitudinal plate and an inner longitudinal plate, wherein said inner longitudinal plate is orthogonally connected to said upper longitudinal plate and to the lower longitudinal plate and wherein the upper longitudinal plate and the lower longitudinal plate are parallel to each other. Further preferably, the transverse length of the lower longitudinal plate is smaller than the transverse length of the upper longitudinal plate. These preferred embodiments are particularly relevant for the suitable junction between the T-profile element (8) and the first panel (12) and the second panel (11).

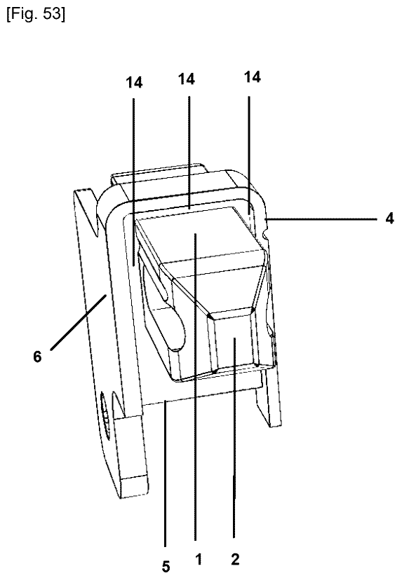

FIGS. 10 and 11 illustrate a preferred embodiment of a first profiled rail (10), wherein the first longitudinal plate (15) and the second longitudinal plate (16) are parallel to each other and wherein each said longitudinal plate (15, 16) is orthogonally connected to a first cross plate (17) and to a second cross plate (18), wherein the first cross plate (17) is disposed in an upper position relative to the first longitudinal plate (15) and to the second longitudinal plate (16), and wherein the second cross plate (18) is disposed in an intermediate position relative to the first longitudinal plate (15) and to the second longitudinal plate (16), forming an A-profile for the first profiled rail (10). Accordingly, the end of the first profiled rail (10), namely the encasement zone of the end of the first profiled rail (10), wherein the encasement zone is bordered by the ends of said longitudinal plates (15, 16) and of said cross plates (17, 18), is configured to fit into the first gap (13) and to connect to the connecting rod (1) of said support device for board panels. Additionally, the zone bordered by the inner faces of the longitudinal plates (15, 16) of the first profiled rail (10) and the lower face of said second intermediate cross plate (18) is configured to be connected to the first panel (12). Further preferably, as illustrated in FIG. 10, the inner faces of the longitudinal plates (15, 16) disposed in the encasement zone of the first profiled rail (10) include longitudinal projections, which are configured for a firmer connection to the connecting rod (1) of said support device for board panels and to provide greater mechanical resistance to the first profiled rail (10).

Similarly, FIGS. 10 and 11 illustrate a preferred embodiment of a second profiled rail (9), wherein the first longitudinal plate (19) and the second longitudinal plate (20) are parallel to each other and wherein each said longitudinal plate (19,20) is orthogonally connected to a first cross plate (21) and to a second cross plate (22), wherein the first cross plate (21) is disposed in an upper position relative to the first longitudinal plate (19) and to the second longitudinal plate (20), and wherein the second cross plate (22) is disposed in an intermediate position relative to the first longitudinal plate (19) and to the second longitudinal plate (20), forming an A-profile for the second profiled rail (9). Accordingly, the end of the second profiled rail (9), namely the encasement zone of the end of the second profiled rail (9), wherein the encasement zone is bordered by the ends of said longitudinal plates (19,20) and of said cross plates (21,22), is configured to fit into the second gap (14) and to connect to the connecting rod (1) of said support device for board panels. Additionally, the zone bordered by the inner faces of the longitudinal plates (19,20) of the second profiled rail (9) and the lower face of said second intermediate cross plate (22) is configured to be connected to the second panel (11). Further preferably, as illustrated in FIG. 10, the inner faces of the longitudinal plates (19,20) disposed in the encasement zone of the second profiled rail (9) include longitudinal projections, which are configured for a firmer connection to the connecting rod (1) of said support device for board panels and to provide greater mechanical resistance to the second profiled rail (9).

In a third aspect, the present invention refers to a method of preparing of the board panel support and junction system, as defined in the second aspect, characterized by comprising the following steps:
a. Encasement of the first profiled rail (10) into the first gap (13) and connection with the connecting rod (1) of said support device for board panels;
b. Encasement of the second profiled rail (9) into the second gap (14) and connection with the connecting rod (1) of said support device for board panels;
c. Connection between the first panel (12) and said first profiled rail (10);
d. Connection between the second panel (11) and said second profiled rail (9);
e. Insertion of the T-profile element (8) into the interval formed between the first panel (12), the second panel (11) and the intermediate bulkhead (5) of said support device for board panels.

As used throughout the specification, the term “or” is used in the inclusive sense instead of the exclusive sense, unless the exclusive sense is clearly defined in a specific situation. In this context, a phrase of the type “X uses A or B” should be interpreted as including all pertinent inclusive combinations, for example “X uses A”, “X uses B” and “X uses A and B”.

As used throughout the specification, the indefinite article “a” or “one” should be generally interpreted as “one or more”, unless the sense of a singular embodiment is clearly defined in a specific situation.

As presented in this specification, the terms related to examples should be interpreted with the purpose of illustrating an example of something and not indicating a preference.

The subject matter-object described above is provided as an illustration of the present invention and should not be interpreted in a manner that limits it. The terminology employed with the purpose of describing specific embodiments, according to the present invention, should not be interpreted in a way that limits the invention. As used in the specification, the definite and indefinite articles, in their singular form, should be interpreted to include their plural forms as well, unless the context of the specification explicitly indicates otherwise. It shall be understood that the terms “comprise” and “include”, when used in this specification, specify the presence of the characteristics, elements, components, steps and related operations, but do not exclude the possibility that other characteristics, elements, components, steps and operations are also included.

All alterations, provided that they do not modify the essential characteristics of the accompanying claims, should be considered within the ambit of protection of the present invention.

### REFERENCE SIGNS LIST

1. A connecting rod
2. A first end of the connecting rod
3. A second end of the connecting rod
4. A front bulkhead
5. An intermediate bulkhead
6. A rear bulkhead
7. An orifice
8. A T-profile element
9. A second profiled rail
10. A first profiled rail
11. A second panel
12. A first panel
13. A first gap
14. A second gap
15. A first longitudinal plate of a first rail
16. A second longitudinal plate of a first rail
17. A first cross plate of a first rail
18. A second cross plate of a first rail
19. A first longitudinal plate of a second rail
20. A second longitudinal plate of a second rail
21. A first cross plate of a second rail
22. A second cross plate of a second rail

1. A support device for board panels, the support device comprising:
a connecting rod with a first end and a second end;
a front bulkhead, which has a first portion disposed in a preceding position relative to said connecting rod and a second portion disposed on the connecting rod, wherein said first portion is connected to said second portion;
a rear bulkhead, which is disposed in a posterior position relative to said connecting rod and is connected to said second portion of the front bulkhead;
an intermediate bulkhead, which is simultaneously connected perpendicularly to a lower face of the front bulkhead, connected perpendicularly to a lower face of the connecting rod and connected perpendicularly to a lower face of the rear bulkhead; and
an element connecting to a surface including an orifice, which is connected to the rear bulkhead; wherein
a first gap is bordered by a portion of the lower face of the front bulkhead, by a portion of the upper face of the connecting rod, by a portion of the lower face of the rear bulkhead and by a portion of the right face of the intermediate bulkhead; and wherein
a second gap is bordered by a portion of the lower face of the front bulkhead, by a portion of the upper face of the connecting rod, by a portion of the lower face of the rear bulkhead and by a portion of the left face of the intermediate bulkhead.

2. The support device for board panels according to claim 1, wherein at least one of the first end and of the second end are selected from the group consisting of a stem of a prism, a stem of a pyramid, a stem of a cylinder or a stem of a cone.

3. The support device for board panels according to claim 1, wherein the connection between the intermediate bulkhead, the lower face of the front bulkhead, the lower face of the connecting rod and the lower face of the rear bulkhead configure an H-profile.

4. The support device for board panels according to claim 1, wherein the element connecting to a surface including an orifice and the rear bulkhead are disposed sideways relative to the plane including the intermediate bulkhead.

5. The support device for board panels according to claim 1, wherein each side of the connecting rod comprises, relative to the intermediate bulkhead, at least one cavity.

6. A board panel support and junction system, the system comprising a support device for board panels according to claim 1, and by additionally comprising:
a first profiled rail, which has a first longitudinal plate and a second longitudinal plate orthogonally connected to a first cross plate and to a second cross plate, wherein an encasement zone, bordered by said longitudinal plates and by said cross plates, is configured to fit into the first gap and to connect to the connecting rod of said support device for board panels; and
a second profiled rail, which has a first longitudinal plate and a second longitudinal plate orthogonally connected to a first cross plate and to a second cross plate, wherein an encasement zone, bordered by said longitudinal plates and by said cross plates, is configured to fit into the second gap and to connect to the connecting rod of said support device for board panels; and
a first panel, which is configured to fit longitudinally into said first profiled rail; and
a second panel, which is configured to fit longitudinally into said second profiled rail; and
a T-profile element, which is configured to fit longitudinally into the interval formed between the first panel, the second panel and the intermediate bulkhead of said support device for board panels.

7. The board panel support and junction system, according to claim 6, wherein at least one of the first panel and of the second panel is selected from the group consisting of a board configured for writing, a board configured for supporting sheets of paper, a board configured for supporting objects by magnetic means or a board configured for supporting sheets of paper by pins.

8. A method of preparing the board panel support and junction system, according to claim 6, the method comprising the following steps:
a. encasing the first profiled rail into the first gap and connection with the connecting rod of said support device for board panels;
b. encasing the second profiled rail into the second gap and connection with the connecting rod of said support device for board panels;
c. connecting between the first panel and said first profiled rail;
d. connecting between the second panel and said second profiled rail; and
e. inserting the T-profile element in the interval formed between the first panel, the second panel and the intermediate bulkhead of said support device for board panels.
